(19) United States
(12) Patent Application Publication
(10) Pub. No.: US 2026/0244128 A1
(43) Pub. Date: Aug. 20, 2026

(54) MEDIA DETECTION APPARATUS, IMAGE FORMING SYSTEM, AND STORAGE MEDIUM

(71) Applicant: Konica Minolta, Inc., Tokyo (JP)

(72) Inventors: Shota Igo, Tokyo (JP); Hitoshi Asano, Toyokawa-shi (JP); Kenji Izumiya, Tokyo (JP); Akira Okamoto, Tokyo (JP); Masayuki Watanabe, Tokyo (JP); Hiroshi Oyama, Tokyo (JP); Hiroshi Yamaguchi, Tokyo (JP)

(73) Assignee: Konica Minolta, Inc., Tokyo (JP)

(21) Appl. No.: 19/540,413

(22) Filed: Feb. 13, 2026

(30) Foreign Application Priority Data
Feb. 14, 2025 (JP) 2025-022146

(51) Int. Cl. G03G 15/16; G03G 15/00

(52) U.S. Cl. CPC G03G 15/1615; G03G 15/161; G03G 15/5029; G03G 15/5062; G03G 15/6573; G03G 2215/0132

(57) ABSTRACT

A media detection apparatus includes: a stiffness sensor that measures stiffness of a sheet-like medium; and a hardware processor that determines, based on the measured stiffness, whether the medium is a medium in which a plurality of materials is laminated.

### CROSS-REFERENCE TO RELATED APPLICATIONS

The entire disclosure of Japanese Patent Application No. 2025-022146 filed on February 14, 2025, is incorporated herein by reference in its entirety.

### BACKGROUND OF THE INVENTION

### TECHNICAL FIELD

The present disclosure relates to a media detection apparatus, an image forming system, and a storage medium.

### DESCRIPTION OF RELATED ART

Conventionally, in an electrophotographic image forming apparatus, when an image is formed on a medium in which a plurality of sheet materials, such as label paper, is laminated, parameters such as a fixing temperature are set to be different from those used when an image is formed on plain paper in order to avoid a failure such as label peeling in a fixing process. However, when humans manually set parameters, the media type may not be set accurately due to the difficulty and complexity of the method for setting the media type. In this case, there is a problem that a sheet jam or image deterioration is caused.

In view of this, JP 2019-99329A discloses a technique for distinguishing between plain paper and label paper based on detection of transmittance using an optical sensor.

### SUMMARY OF THE INVENTION

However, in the technique described in JP 2019-99329A, since transmittance is affected by paper color, there is a problem that an erroneous determination occurs in distinguishing label paper, which is often colored.

The present disclosure has been made in view of the above-described problem. An object of the present disclosure is to provide a media detection apparatus, an image forming system, and a storage medium capable of detecting, without being affected by color, a medium in which a plurality of sheet materials is laminated.

To achieve at least one of the abovementioned objects, a media detection apparatus reflecting one aspect of the present invention comprises: a stiffness sensor that measures stiffness of a sheet-like medium; and a hardware processor that determines, based on the measured stiffness, whether the medium is a medium in which a plurality of materials is laminated.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an overall configuration of an image forming system of the present embodiment;

FIG. 2 is a block diagram illustrating detailed configurations of a sheet feed device, a media detection apparatus, an image forming apparatus, and a post-processing device;

FIG. 3 is a perspective view illustrating an example of a schematic configuration of a stiffness sensor;

FIG. 4 is a side view illustrating an example of a schematic configuration of the stiffness sensor;

FIG. 5 is a diagram illustrating a structure of label paper;

FIG. 6 is a graph showing the correlation between a press-bending amount X and a stress P when a medium is press-bent;

FIG. 7 is a graph showing the change in the press-bending amount X over time and the change in the stress P over time;

FIG. 8 is a flowchart illustrating a control procedure of media determination processing;

FIG. 9 is a flowchart illustrating a control procedure according to a first media determination algorithm; and

FIG. 10 is a flowchart illustrating a control procedure according to a second media determination algorithm.

### DETAILED DESCRIPTION

Hereinafter, one or more embodiments of the present invention will be described with reference to the drawings. However, the scope of the invention is not limited to the disclosed embodiments.

### 1. Configuration of Image Forming System

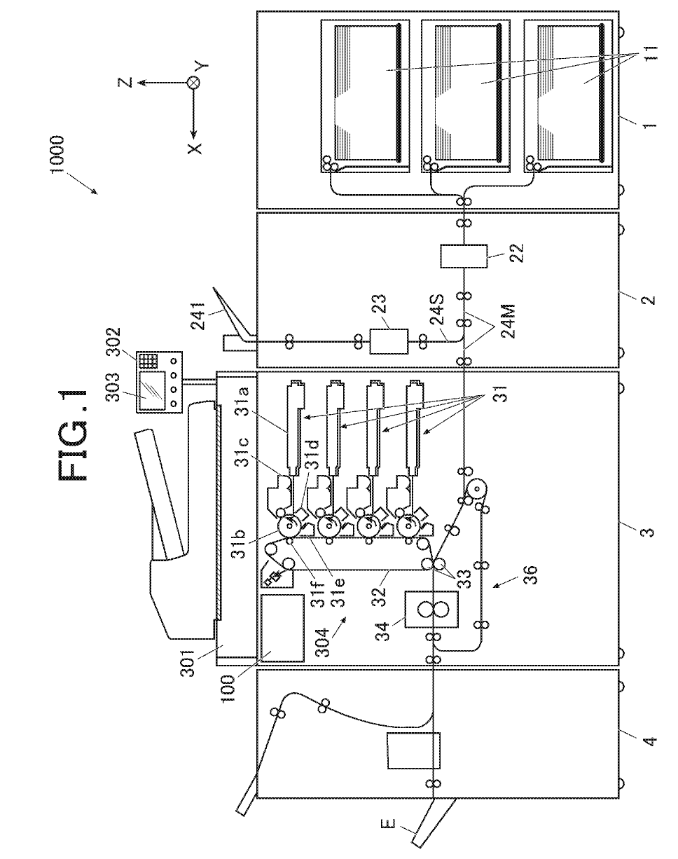

FIG. 1 is a diagram illustrating an overall configuration of an image forming system 1000 of the present embodiment.

The image forming system 1000 includes a sheet feed device 1, a media detection apparatus 2, an image forming apparatus 3, and a post-processing device 4.

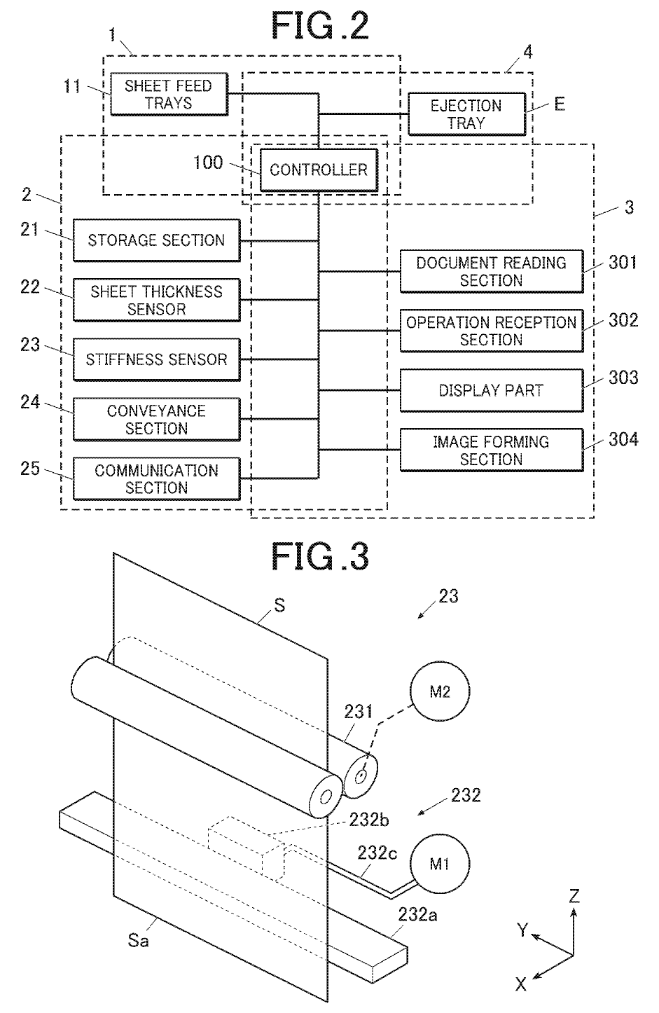

FIG. 2 is a block diagram of the sheet feed device 1, the media detection apparatus 2, the image forming apparatus 3, and the post-processing device 4.

### Sheet Feed Device

The sheet feed device 1 includes a plurality of sheet feed trays 11. The sheet feed device 1 feeds media to record images one sheet at a time from one of the sheet feed trays 11 that have been selected and set under the control of a controller (hardware processor) 100.

### Media Detection Apparatus

The media detection apparatus 2 includes a sensor that measures physical properties and the like of a medium. The media detection apparatus 2 measures, with the sensor, the medium fed from the sheet feed device 1 on its path. The media detection apparatus 2 can specify the physical properties and the like (characteristic information) of the medium based on the measurement result. The characteristic information of the medium may be a characteristic value itself of the medium, or may be a value indicating the characteristic, such as a current or a voltage of a sensor corresponding to the characteristic value of the medium. The media detection apparatus 2 may output the physical property value obtained by the measurement as it is to the outside, for example, to the image forming apparatus 3.

The media detection apparatus 2 includes the controller 100, a storage section 21, a sheet thickness sensor 22, a stiffness sensor 23, a conveyance section 24, and a communication section 25.

### Controller

The controller 100 includes a central processing unit (CPU), a random-access memory (RAM), and the like.

The CPU of the controller 100 controls the measurement operation by the sheet thickness sensor 22, the measurement operation by the stiffness sensor 23, and the media conveyance operation by the conveyance section 24. The RAM of the controller 100 temporarily stores measurement results by the sheet thickness sensor 22 and the stiffness sensor 23, and the like.

The storage section 21 stores a control program and measurement setting data for a measurement operation by the sheet thickness sensor 22, a control program and measurement setting data for a measurement operation by the stiffness sensor 23, and the like. The storage section 21 includes a nonvolatile memory such as an HDD or a flash memory.

The conveyance section 24 receives the medium sent out from the sheet feed device 1 on the right side in FIG. 1 and sends out the medium to the image forming apparatus 3 on the left side in FIG. 1 along a first conveyance path 24M. A second conveyance path 24S branches from the middle of the horizontally extending first conveyance path 24M. A leading end of the second conveyance path 24S is connected to a purge tray 241.

The sheet thickness sensor 22 is disposed on the first conveyance path 24M.

The stiffness sensor 23 is disposed on the second conveyance path 24S.

The sheet thickness sensor 22 measures the sheet thickness of a medium and outputs the measurement result.

The sheet thickness sensor 22 includes a conveyance roller pair and a measurement section that measures a distance between the axes of the conveyance roller pair. At least one of the conveyance roller pair moves according to the thickness of a medium passing through a nip between the rollers. The measurement section includes, for example, an actuator, an encoder, a light emitter, and a light receiving section. The shaft position of the movable driven roller is displaced according to the thickness of the medium nipped by the conveyance roller pair. The sheet thickness sensor 22 measures the height of the displaced shaft to measure the sheet thickness of the medium.

The sheet thickness sensor 22 can measure the sheet thickness of the medium while moving each conveyed medium at the conveyance speed.

The stiffness sensor 23 measures the stiffness of the sheet-like medium. The stiffness of the medium is an index indicating resistance (stress) when the medium is bent.

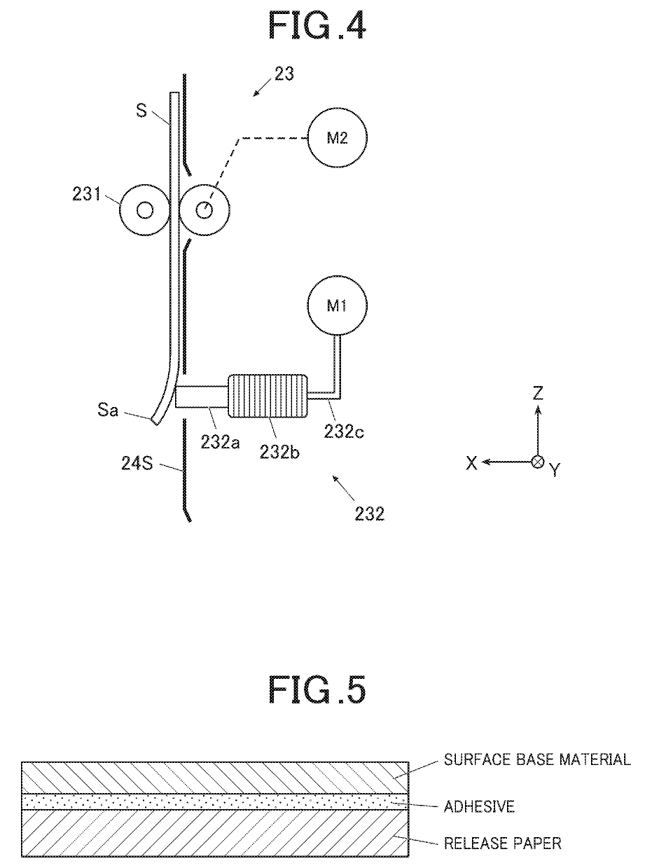

FIG. 3 is a perspective view illustrating the configuration of the stiffness sensor 23. FIG. 4 is a side view illustrating the configuration of the stiffness sensor 23.

The stiffness sensor 23 includes media holding rollers 231 as a media holding member (media holder) that holds one end portion of the medium S, a pressing section 232, a media end portion sensor (not illustrated), and a pressing home position sensor (not illustrated). In the examples illustrated in FIGS. 3 and 4, the media holding rollers 231 are also included in the conveyance section 24 and have the function of conveying the medium S, but a separate member may be used.

The pressing section 232 includes a pressing member (presser) 232a, a stress measuring part (stress measurer) 232b, a support mechanism 232c, and a motor M1.

The pressing member 232a is a member formed in an elongated shape in the medium width direction (Y-axis direction) so as to be able to contact the entire width of the medium S conveyed in the medium conveyance direction (Z-axis direction). The pressing member 232a presses the medium S.

The stress measuring part 232b includes, for example, a pressure sensor, and detects a pressing force (stress) from the medium S when the pressing member 232a presses the medium S.

The support mechanism 232c supports the pressing member 232a and the stress measuring part 232b movably in the X-axis direction.

The motor M1 is a drive source for moving the pressing member 232a and the stress measuring part 232b in the X-axis direction via the support mechanism 232c. The motor M1 includes, for example, a stepping motor.

A method for acquiring the stiffness of the medium S will be described below.

As illustrated in FIGS. 3 and 4, under the control of the controller 100, the conveyance section 24 stops a motor M2 that drives the media holding rollers 231 to stop the conveyance of the medium S at a predetermined position on the second conveyance path 24S. At this time, the medium S is sandwiched and held between the media holding rollers 231. The media holding rollers 231 hold the medium S at a position a predetermined distance from an end portion Sa of the medium S. At this time, based on information obtained from the media end portion sensor, the controller 100 controls the media holding rollers 231 to hold the medium S at the position.

Next, the pressing section 232 moves the pressing member 232a in the positive X-axis direction by the driving of the motor M1. As a result, the end portion Sa (free end) of the medium S is pressed and bent by the pressing member 232a as illustrated in FIG. 4. At this time, a position at which the pressing member 232a starts to come into contact with the sheet surface (right side surface in FIG. 4) of the medium S while the medium S is not bent is defined as a home position of the pressing member 232a in the X-axis direction. At this time, based on information obtained from the pressing home position sensor, the controller 100 controls the motor M1 to move the pressing member 232a to the home position.

The force received from the medium S when the medium S is bent from the home position by the pressing member 232a by a predetermined amount (e.g., 4 mm) is detected by the stress measuring part 232b.

The pressing section 232 presses the medium S by pressing the pressing member 232a against the medium S at a position closer to the end portion Sa of the medium S than the position at which the medium S is held by the media holding rollers 231. The press-bending amount of the medium S by the pressing member 232a can be grasped by the number of pulse signals input to the driver of the motor M1.

The stiffness sensor 23 outputs the stress detected by the stress measuring part 232b to the controller 100. The controller 100 calculates the stiffness of the medium based on the pressure value of the detected stress.

Although FIGS. 3 and 4 illustrate the example in which the pressing member 232a presses the medium S from right to left, the present disclosure is not limited thereto. The pressing member 232a may press the medium S from left to right.

The stiffness sensor 23 performs the measurement while the conveyance of the medium is temporarily stopped.

The communication section 25 controls communication between the media detection apparatus 2 and the sheet feed device 1, the image forming apparatus 3, and the post-processing device 4 in the image forming system 1000.

Based on the result of measurement by the stiffness sensor 23, the controller 100 performs media determination processing, which will be described later, to determine whether the medium is a medium in which a plurality of materials is laminated.

The controller 100 outputs, to the image forming apparatus 3 via the communication section 25, the determination result as to whether the medium is a medium in which a plurality of materials is laminated.

Under the control of the controller 100, the conveyance section 24 conveys the medium for which the measurement by the stiffness sensor 23 has been completed to the image forming apparatus 3 or ejects the medium to the purge tray 241, based on the determination result. For example, when image formation is preset to be performed on a medium in which a plurality of materials is laminated, if it is determined that the medium is a medium in which a plurality of materials is laminated, the medium is conveyed to the image forming apparatus 3, and if it is determined that the medium is not a medium in which a plurality of materials is laminated, the medium is ejected to the purge tray 241.

### Image Forming Apparatus

The image forming apparatus 3, for example, forms an image of image data read from a document on a medium and outputs the medium. The image forming apparatus 3 electrophotographically forms an image on a medium based on image data received from an external device (not illustrated) and outputs the medium. That is, the image forming apparatus 3 is a multifunction peripheral. The image forming apparatus 3 may be connected to an external device, for example, a PC via a local area network (LAN) or the like.

The image forming apparatus 3 includes the controller 100, a document reading section 301, an operation reception section 302, a display part (display) 303, an image forming section (image former) 304, a storage section (not shown), a communication section (not shown), and the like.

The CPU of the controller 100 performs various settings and operations related to image formation in accordance with operation signals input from the operation reception section 302 or instruction signals received by the communication section.

The document reading section 301 reads an image of a document placed on a document plate or in an automatic document feeder (ADF).

The document reading section 301 scans and exposes the document by an optical system of a scanning exposure device and reads its reflected light by a line image sensor to obtain an image signal. Next, the document reading section 301 performs processing such as A/D conversion, shading correction, and compression on the image signal to generate image data.

The operation reception section 302 receives an input operation from the outside by a user or the like. The operation reception section 302 includes a touch screen provided on the screen of the display part 303, and various hard keys arranged around the screen of the display part 303. The operation reception section 302 converts the received operation content into an operation signal corresponding to the content and outputs the operation signal to the controller 100. The touch screen may be, for example, any one of a pressure-sensitive type, an electrostatic type, and an optical type.

The display part 303 includes, for example, a color liquid crystal display and displays various kinds of information based on the control of the controller 100. Specifically, when the medium is determined to be label paper (a medium in which a plurality of materials is laminated) in the media determination processing described later, the controller 100 functions as a display controller that causes the display part 303 to display that the medium is label paper or a sticker.

The image forming section 304 applies and fixes a color material to a medium based on image data to be formed.

The controller 100 functions as a setting section that sets control parameters in the image formation by the image forming section 304 based on the characteristic information of the medium, such as the sheet thickness or the stiffness, received from the media detection apparatus 2. The image forming section 304 performs image formation on the medium using the control parameters. The characteristic information of the medium also includes a result of media determination processing by a determination section described later.

The image forming section 304 includes four writing sections 31, an intermediate transfer belt 32, a secondary transfer roller 33, and a fixing section 34.

The four writing sections 31 are arranged in series (tandem) along the belt surface of the intermediate transfer belt 32 and form images of respective colors of C (cyan), M (magenta), Y (yellow), and K (black). The configuration of each writing section 31 may be the same among the colors. For example, each of the writing sections 31 includes an optical scanning section 31a, a photoreceptor 31b, a developing section 31c, a charging section 31d, a cleaning section 31e, and a primary transfer roller 31f.

In each of the writing sections 31, the charging section 31d uniformly charges the photoreceptor 31b. The optical scanning section 31a emits a light beam based on the original image data to scan and expose the charged photoreceptor 31b, thereby forming an electrostatic latent image. The developing section 31c supplies a color material such as toner to the electrostatic latent image to develop the image, thereby forming the image on the photoreceptor 31b.

The four writing sections 31 sequentially transfer the respective images formed on the photoreceptors 31b onto the intermediate transfer belt 32 in a superimposed manner by the respective primary transfer rollers 31f. The writing sections 31 form images of the respective colors on the intermediate transfer belt 32 by this transfer (primary transfer). The intermediate transfer belt 32 is wound around a plurality of rollers and moves in a circumferential direction. After the primary transfer, the cleaning section 31e removes the color material remaining on the photoreceptor 31b.

The image forming apparatus 3 causes the medium to pass through the position of the secondary transfer roller 33 in accordance with the timing at which the image on the intermediate transfer belt 32 moving in the circumferential direction reaches the position of the secondary transfer roller 33. The secondary transfer roller 33 includes a pair of rollers. One of the rollers is pressed against the intermediate transfer belt 32, and the other of the rollers is one of the plurality of rollers around which the intermediate transfer belt 32 is wound. The image is transferred (secondary transfer) onto the medium from the intermediate transfer belt 32 pressed by the secondary transfer roller 33.

The medium on which the image has been secondarily transferred is conveyed to the fixing section 34 and subjected to fixing processing. The fixing section 34 includes a pair of fixing rollers that are in pressed contact with each other. At least one of the fixing rollers is heatable. The fixing rollers fix the image to the medium by heating and pressing the medium passing between the fixing rollers.

When images are to be formed on both sides of a medium, the medium having an image formed and fixed on one side is sent to a reversal path 36 to have its front and back sides reversed. Thereafter, the medium is returned to an upstream position of the secondary transfer roller 33. When image formation is to be performed on one side only or when image formation on both sides is completed, the medium is ejected from the fixing section 34 to the post-processing device 4.

### Post-processing Device

Under the control of the controller 100, the post-processing device 4 performs post-processing on the medium on which the image has been formed. The post-processing includes, for example, sorting, cutting, stapling, folding, and the like. The post-processing device 4 ejects the post-processed medium to an ejection tray E or the like.

### 2. Operation of Image Forming System

Next, an operation of the image forming system 1000 will be described.

The image forming system 1000 causes a setting section of the image forming apparatus 3 to set control parameters for image formation based on a determination result of the determination section (described later) of the media detection apparatus 2. The image forming system 1000 causes the image forming section 304 to form an image on a medium using the control parameters.

The controller 100 of the media detection apparatus 2 performs the media determination processing using a first media determination algorithm and a second media determination algorithm. The controller 100 functions as the determination section that determines whether the medium is a medium in which a plurality of materials is laminated based on the measurement results of the press-bending amount of the medium and the measured stress. The medium in which a plurality of materials is laminated is, for example, label paper, a sticker, or the like. Hereinafter, label paper will be described as an example.

The first media determination algorithm determines whether the medium is label paper based on coefficients of an approximation function indicating a relationship between the press-bending amount X and the stress P at the time of measuring the stiffness of the medium.

Since normal paper has a homogeneous structure and thus exhibits a characteristic similar to elasticity, the stress P when the medium is press-bent by the pressing member is proportional to the press-bending amount X, with a correlation of P = AX. A is a constant of the hardness of the medium and changes according to the thickness, width, material, temperature, and humidity of the medium.

On the other hand, as illustrated in FIG. 5, label paper has a structure in which two sheets of paper, i.e., a surface base material and a release paper, are laminated with an adhesive. Since the adhesive serves as a buffer between the two sheets of paper, a correlation approximated by P = AX-X0 is exhibited due to characteristics other than elasticity. The coefficient X0 is a region in which the change in the stress is small at the initial stage of press-bending. The relation between the press-bending amount X and the stress P in label paper exhibits a normal rate of change A after the press-bending amount exceeds X0.

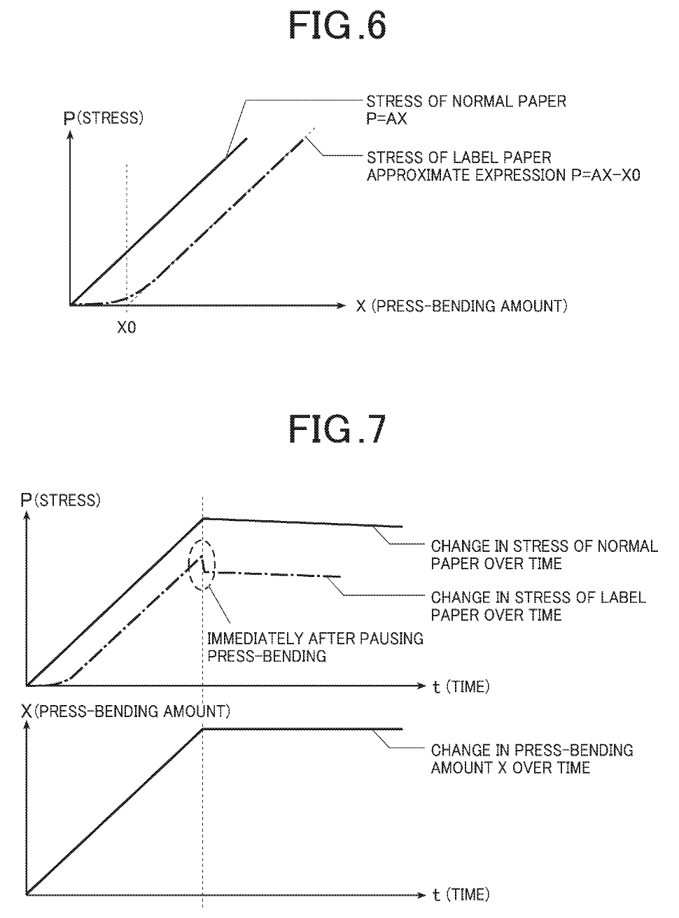

From the relation between the press-bending amount X and the stress P for each of normal paper and label paper as described above and the coefficient X0 of the approximate expression thereof, it is possible to determine that the medium is label paper when X0 is equal to or greater than a predetermined threshold value. FIG. 6 is a graph showing the relationship between the press-bending amount X and the stress P for each of normal paper and label paper.

A slight X0 may appear even for normal paper due to curling or the like, but that is sufficiently smaller than X0 for label paper.

After the press-bending of the medium is stopped, the second media determination algorithm determines, based on the change in the stress over time with the press-bending paused, whether the medium is label paper.

As illustrated in FIG. 5, label paper has a structure in which two sheets of paper are laminated with an adhesive. Therefore, label paper has a more prominent viscoelasticity than normal paper having a homogeneous structure.

In the stiffness sensor, the difference between elasticity and viscoelasticity becomes markedly apparent in the change in the stress over time after pausing the press-bending of the medium in the stiffness measurement.

In normal paper exhibiting elasticity, although the stress develops in response to the press-bending amount, the influence of press-bending speed on the stress is extremely small.

On the other hand, in label paper exhibiting viscoelasticity, the stress develops in response to the press-bending amount in the same manner as in normal paper, and the stress also develops in response to the press-bending speed due to the viscosity of label paper.

This difference in characteristics between normal paper and label paper creates a difference in rate of change (rate of decrease) such that normal paper has a small decrease in the stress immediately after pausing the press-bending, while label paper has a large decrease in the stress for a predetermined time immediately after pausing the press-bending. A graph showing the change in the press-bending amount X over time and a graph showing the change in the stress P over time are arranged in FIG. 7. In FIG. 7, t represents time.

Using this difference in the rate of change, the medium can be determined to be label paper when the change in the stress immediately after pausing the press-bending is equal to or greater than a predetermined threshold value.

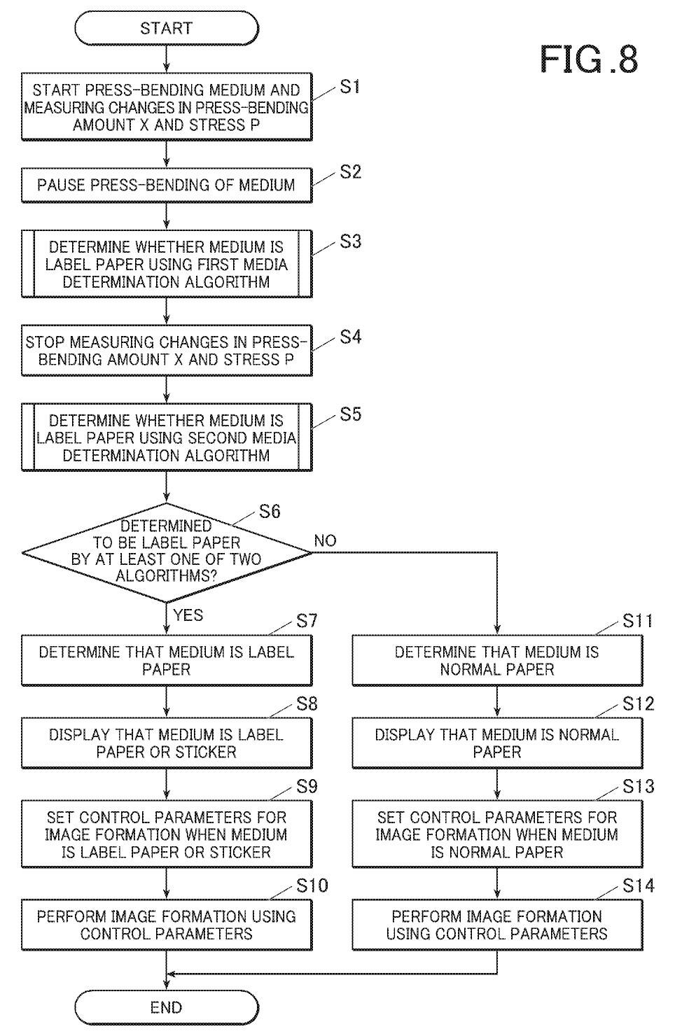

FIG. 8 is a flowchart illustrating a control procedure of the media determination processing executed by the controller 100 of the media detection apparatus 2.

The initial state in which the media determination processing is executed will be described.

The medium S is held by the media holding rollers 231 at a position where the end portion Sa of the medium S is separated from the media holding rollers 231 by a predetermined distance. The pressing member 232a is located at the home position by the motor M1. The home position is a position at which the pressing member 232a starts to come into contact with the sheet surface (right side surface in FIG. 4) of the medium S while the medium S is not bent.

The controller 100 drives the motor M1, starts press-bending the medium by the pressing member 232a, and at the same time, starts measuring changes in the press-bending amount X and the stress P (step S1).

Next, the controller 100 pauses the press-bending of the medium at the time when the press-bending amount X reaches a predetermined amount (e.g., 4 mm) (step S2).

Next, the controller 100 determines whether the medium is label paper using the first media determination algorithm (step S3). The flow of the determination processing by the first media determination algorithm will be described later.

Next, after a predetermined time has elapsed, the controller 100 stops measuring the changes in the press-bending amount X and the stress P (step S4).

Next, the controller 100 determines whether the medium is label paper using the second media determination algorithm (step S5). The flow of the second media determination algorithm will be described later.

If the medium is determined to be label paper by at least one of the two algorithms (step S6: YES), the controller 100 determines that the medium is label paper (step S7).

Next, the controller 100 causes the display part 303 to display, via the communication section 25, that the medium is label paper or a sticker (step S8).

Next, the controller 100 sets control parameters for image formation performed when the medium is label paper or a sticker (step S9). Specifically, when the medium is determined to be label paper or a sticker, the fixing pressure in the fixing process is set weaker as a control parameter than that for normal paper such as plain paper. In addition, as a control parameter, the fixing temperature in the fixing process is set lower than that for normal paper such as plain paper. With these settings, it is possible to avoid a failure such as label peeling in the fixing process.

Next, the controller 100 causes the image forming section 304 to form an image on the medium using the control parameters set in step S9 (step S10).

If the medium is determined not to be label paper by both of the two algorithms (step S6; NO), the controller 100 determines that the medium is normal paper (step S11).

Next, the controller 100 causes the display part 303 to display, via the communication section 25, that the medium is normal paper (step S12).

Next, the controller 100 sets control parameters for image formation on normal paper (step S13).

Next, the controller 100 causes the image forming section 304 to form an image on the medium using the control parameters set in step S13 (step S14).

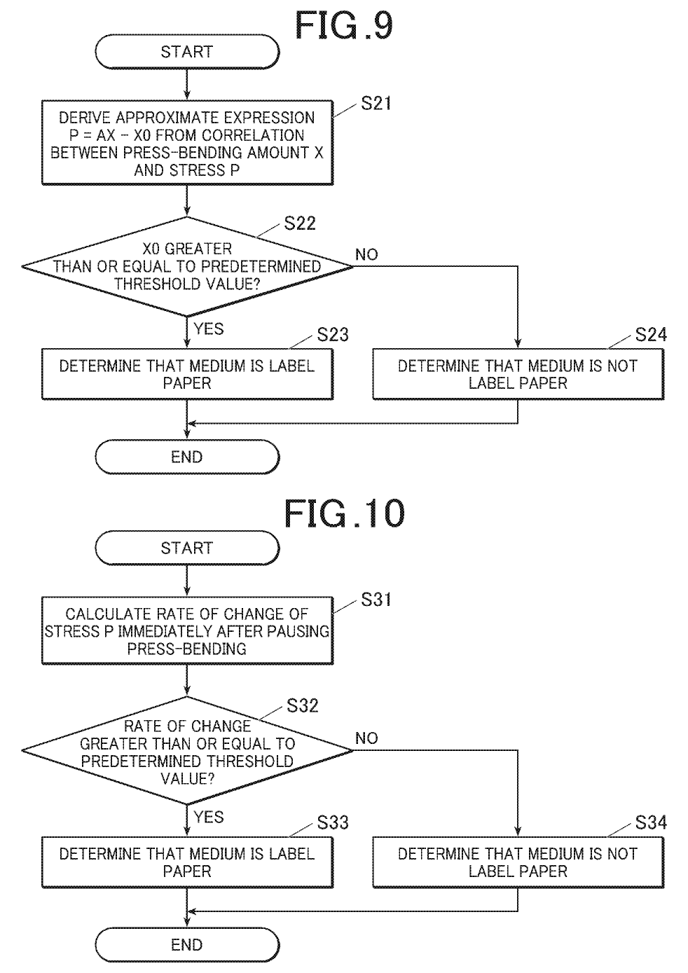

FIG. 9 is a flowchart of the media determination processing according to the first media determination algorithm. The controller 100 derives an approximate expression P = AX - X0 from the correlation between the press-bending amount X and the stress P (step S21).

If X0 is equal to or greater than a threshold value (step S22; YES), the controller 100 determines that the medium is label paper (step S23).

If X0 is less than the threshold value (step S22; NO), the controller 100 determines that the medium is not label paper (step S24).

FIG. 10 is a flowchart of the media determination processing according to the second media determination algorithm. The controller 100 calculates the rate of change of the stress P for a predetermined time immediately after pausing the press-bending (step S31).

If the rate of change of the stress P is equal to or greater than a predetermined threshold value (step S32; YES), the controller 100 determines that the medium is label paper (step S33).

If the rate of change of the stress P is less than the predetermined threshold value (step S32; NO), the controller 100 determines that the medium is not label paper (step S34).

### 3. Modification Example

Although the present embodiment has been described above, the specific configuration is not limited to the above-described present embodiment and can be changed without departing from the spirit and scope of the invention. Hereinafter, a modification example of the present embodiment will be described.

A modification example in which measurement data of the sheet thickness sensor 22 is added in the media determination by the media detection apparatus 2 will be described.

The sheet thickness is related to the constant A of the hardness of the medium, and the value of A increases as the sheet thickness increases. Therefore, the media detection apparatus 2 can more accurately set the constant A in the medium determination by the first media determination algorithm by obtaining data of the sheet thickness of the medium by the sheet thickness sensor and reflecting the data in the value of the constant A of the hardness of the medium. Therefore, the media determination can be performed more accurately.

### 4. Effects

As described above, the media detection apparatus 2 according to the present embodiment includes the stiffness sensor 23 that measures the stiffness of a medium, and determines, based on the measured stiffness, whether the medium is a medium in which a plurality of materials is laminated.

Therefore, label paper can be detected without being affected by paper color.

The image forming system 1000 according to the present embodiment causes the setting section of the image forming apparatus 3 to set control parameters for image formation based on the determination result of the determination section of the media detection apparatus 2. Furthermore, the image forming system 1000 of the present embodiment forms an image on the medium by the image forming section 304 using the control parameters.

Therefore, the control parameters can be more accurately set according to the paper type.

Note that in the above embodiment, the controller 100 has been described as a single controller that comprehensively controls the operations of all the devices, but the present disclosure is not limited thereto. For example, the sheet feed device 1, the media detection apparatus 2, the image forming apparatus 3, and the post-processing device 4 may each include a separate controller.

Furthermore, in the above-described embodiment, the determination is performed using the two algorithms of the first media determination algorithm and the second media determination algorithm in the media determination processing, but the present disclosure is not limited thereto. Only one algorithm may be used for the media determination processing. For example, the determination may be performed using only the first media determination algorithm. In this case, step S5 in FIG. 8 is omitted. Similarly, the determination may be performed using only the second media determination algorithm. In this case, step S3 in FIG. 8 is omitted.

Furthermore, in the above embodiment, the medium is determined to be label paper if the media is determined to be label paper by at least one of the first media determination algorithm and the second media determination algorithm in the media determination processing, but the present disclosure is not limited thereto. For example, the medium may be determined to be label paper if the medium is determined to be label paper by both the first media determination algorithm and the second media determination algorithm. In this case, the determination in step S6 in FIG. 8 is changed to “DETERMINED TO BE LABEL PAPER BY BOTH ALGORITHMS?".

In the above description, the storage section 21 including a nonvolatile memory such as an HDD or a flash memory has been described as an example of a computer-readable medium that stores a program related to the setting control of the present disclosure, but the present disclosure is not limited thereto. As other computer-readable media, other nonvolatile memory such as an MRAM and portable recording media such as a CD-ROM and a DVD disk can be applied. As a medium for providing data of the program according to the present disclosure via a communication line, a carrier wave is also applied to the present disclosure.

In addition, the specific configurations, the contents and sequence of the processing operations, and the like described in the above embodiment can be appropriately changed without departing from the spirit and scope of the present disclosure. The scope of the present disclosure includes the scope of the invention described in the claims and the scope of equivalents thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A media detection apparatus comprising:
a stiffness sensor that measures stiffness of a sheet-like medium; and
a hardware processor that determines, based on the measured stiffness, whether the medium is a medium in which a plurality of materials is laminated.

2. The media detection apparatus according to claim 1, wherein the medium in which the plurality of materials is laminated is label paper or a sticker.

3. The media detection apparatus according to claim 1, wherein
the stiffness sensor includes:
a media holder that holds the medium;
a presser that press-bends the medium; and
a stress measurer that measures a stress applied to the presser, and
the hardware processor determines, based on a measurement result of a press-bending amount of the medium and the measured stress, whether the medium is the medium in which the plurality of materials is laminated.

4. The media detection apparatus according to claim 3, wherein the hardware processor
derives an approximation function of a relationship between the press-bending amount and the stress, and
determines, based on a coefficient of the approximation function, whether the medium is the medium in which the plurality of materials is laminated.

5. The media detection apparatus according to claim 3, wherein
the stiffness sensor measures, after stopping press-bending of the medium in a measurement of the stiffness, a change in the stress over time with the press-bending paused, and
the hardware processor determines, based on a rate of decrease of the stress for a predetermined time, whether the medium is the medium in which the plurality of materials is laminated.

6. The media detection apparatus according to claim 2, wherein, when determining that the medium is the medium in which the plurality of materials is laminated, the hardware processor causes a display to display that the medium is the label paper or the sticker.

7. An image forming system comprising:
the media detection apparatus according to claim 1; and
an image former, wherein
the hardware processor sets, based on a determination result as to whether the medium is the medium in which the plurality of materials is laminated, a control parameter for image formation, and
the image former forms an image on the medium using the control parameter set by the hardware processor.

8. A non-transitory computer-readable storage medium storing a program, the program causing a computer to determine, based on data acquired from a stiffness sensor, whether a medium is a medium in which a plurality of materials is laminated.
